(19) United States
(12) Patent Application Publication
(10) Pub. No.: US 2007/0075928 A1
(43) Pub. Date: Apr. 5, 2007

(54) Digital display apparatus and display method thereof

(76) Inventors: Masanori Takeuchi, Tokyo (JP); Yutaka Chiaki, Yokohama (JP); Yuichiro Kimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/543,108

(22) Filed: Oct. 5, 2006

(30) Foreign Application Priority Data
Oct. 5, 2005 (JP) JP2005-292106

(51) Int. Cl. G09G 3/28

(52) U.S. Cl. 345/63

(57) ABSTRACT

In a display method of a PDP apparatus or the like, there is provided a technique for reducing or eliminating dynamic false contours in a display video image by determining and detecting an occurrence region of dynamic false contours in display data with good accuracy for coping. In a false-contour detection unit in a PDP apparatus, a carry detection unit detects, as a dynamic-false-contour occurrence region, a pixel region corresponding to carry in an SF on-cell pattern of adjacent pixels based on a video image signal in view of a predetermined condition. In a width control unit, a detection region is expanded according to a motion amount. A detection region is expanded according to a motion amount in a width control unit. A diffusion processing (actual gray-scale number restriction processing) based on dither or error diffusion is performed to the detection region. A detection condition of the carry is that an on-cell state of an SF with higher weighting is different between the adjacent gray scales sandwiching the carried gray scale therebetween.

### CROSS-REFERENCE TO RELATED APPLICATION

The present application claims priority from Japanese patent application No. JP 2005-292106 filed on Oct. 5, 2005, the content of which is hereby incorporated by reference into this application.

### BACKGROUND OF THE INVENTION

The present invention relates to a technique for a digital display apparatus such as a plasma display apparatus (PDP apparatus) and a display method, and in particular to a technique for coping with noise or video image quality degray scale such as dynamic false contour occurring in a process for performing gray scale display using a subfield process.

In a digital display apparatus, such as a PDP apparatus, which controls display of pixels on a display panel based on digital signals of display data, display of a video image (motion picture) is performed using a well-known subfield process. An occurrence of noises such as a dynamic false contour becomes problematic according to gray-scale display using the subfield process.

In a subfield process in a PDP apparatus, one field corresponding to an image (a frame) on a display panel screen is composed of a plurality of weighted subfields (abbreviated as “SF”), for example, ten SFs (SF1 to SF10). Gray scale is displace according to a combination (SF on-cell pattern) of light emission (on)/no light emission (off) cell of respective SFs different in weighting on one field. The respective SFs are weighted so that their sustain periods (Ts), namely, the number of sustain discharge times are different from one another.

In gray-scale display in the subfield process, there occurs a phenomenon that a contour with unnatural color that is not present under normal circumstances is generated especially in a moving portion due to an image retention effect to human eye. The phenomenon is generally called “dynamic false contour” or the like. A technique for coping with the dynamic false contour is demanded.

A technique for coping with the dynamic false contour in the display apparatus has been described in, for example, Japanese Patent No. 3322809 (Patent Document 1). In the conventional art, pixels where the dynamic false contour easily occurs are detected based upon determination for each pixel. A converting processing to the detected pixels is performed so that the dynamic false contour does not occur.

### SUMMARY OF THE INVENTION

It is important to detect accurately a region where the dynamic false contour occurs in order to reduce or cancel the dynamic false contour (hereinafter, also called “noise” simply). In the conventional art, a pixel where a motion is detected and a pixel region having gray scale in which the dynamic false contour easily occurs have been determined as a dynamic-false-contour occurrence region and detected in the display data. A diffusion process based upon dithering or error diffusion has been applied to the detected region as ways of coping. In the conventional art, a noise occurrence region has been determined and detected for each pixel on an image. In other words, the dynamic-false-contour occurrence region is a pixel region where it is expected in advance that the dynamic false contour will actually occur on a display video image.

The above-described method can cope with noise to some extent. However, the dynamic false contour occurs when on states of the SFs heavily weighted are different in an SF's on-cell pattern of spatially neighboring pixels. Even if respective gray scales of neighboring pixels are ones in which the dynamic false contour hardly occurs in a video image including a motion portion, when their gray scales are ones that stride gray scales in which the dynamic false contour easily occurs (when they constitute a set of near gray scales), the dynamic false contour can occur in a region of the neighboring pixels.

FIG. 20 shows one example of occurrence of dynamic false contour. Reference numbers “p1” to “p8” are examples of continuous gray scales and they indicate SF on-cell patterns based on SF1 to SF8. The case where weighting is increased from SF1 toward SF10 is shown. The gray scale at p5 is a gray scale corresponding to carrying to SF8 in the SF on-cell pattern. That is, SF7 is the maximum on-state SF (the most heavily weighted SF) in a range of p1 to p4, but SF8 is the maximum on-state SF in a range of p5 to p8. Since it is proven in advance that p5 which is a gray scale corresponding to such carrying is a gray scale in which dynamic false contour easily occurs by influence of highly weighted SF8, p5 is detected as a dynamic-false-contour occurrence region to be processed correspondingly.

It is considered that a set of gray scales of p1 and p6 sandwiching the gray scale of the above p5 constitute two neighboring pixels in an image. In this case, the on states of highly weighted SF8 and SF6 are different in the SF on-cell pattern of the neighboring pixels due to p1 and p6. Respective p1 and p6 have been conventionally handled as gray scales in which dynamic false contour hardly occurs. That is, when each of p1 and p6 is a single pixel, it is not detected as a dynamic false contour. However, since the case where p6 in the neighboring region due to p1 and p6 is viewed from its front and the case where it is viewed obliquely as shown by an oblique sight line are different in the on state in the highly weighted SF, the dynamic false contour occurs.

As described above, in the conventional art, there is a possibility that detection omission occurs due to insufficient detection of the dynamic-false-contour occurrence region. That is, such a problem arises that handling of noise is insufficient.

Even if a pixel region where dynamic false contour occurs can be detected accurately according to the conventional method, when a motion amount of the pixel region is large, there is a problem that dynamic false contour or a noise region analogous thereto is widely observed due to its image retention. FIG. 21 shows occurrence of noise due to the image retention at such a motion time. A pixel P is one of dynamic-false-contour occurrence and detection regions in a display panel screen (a horizontal section is shown as an example). When a motion of P on display is found, a human eye tracks the motion of P. However, when a motion amount of the P is large, the image-retention region due to the P is also perceived as a dynamic false contour or noise analogous thereto.

The present invention is made in view of these problems, and an object thereof is to provide, in a digital display apparatus such as a PDP apparatus and a display method thereof, a technique for reducing or eliminating dynamic false contours in a display video image by determining and detecting an occurrence region of dynamic false contours in display data with good accuracy for coping.

Outlines of representative ones of the inventions disclosed in the present application will be explained briefly as follows. In order to achieve the above object, the present invention is a technique for a digital display apparatus such as a PDP apparatus that performs gray-scale display using a subfield method and for a display method in the digital display apparatus, comprising technical means as described below. The digital display apparatus according to the present invention includes: a display control and drive circuit unit for performing a processing of digital data according to the display method; and a display panel unit driven by the circuit unit.

First, a technique according to the present invention has a means for determining, in order to detect a dynamic-false-contour occurrence region in display data with high precision, spatially neighboring pixels in the display data to detect the region without depending on determination and detection for each pixel performed in the conventional art. In the first means, when SF on-cell patterns in the neighboring pixels are compared with each other and some conditions (detection conditions) for detecting the above-described region are satisfied, a corresponding pixel region is determined as a “carry-including” region, namely, a dynamic-false-contour occurrence region in the display method and a dynamic-false-contour detection region is determined based on the occurrence region. A predetermined noise addressing (reducing or eliminating) processing is performed to the detection region determined like this. An occurrence of the dynamic false contour in an actual display video image is reduced or eliminated by the noise addressing processing.

Secondly, the above-mentioned technique has a means for performing a processing for, based on calculation of a motion amount from the display data and according to the motion amount information, expanding the dynamic-false-contour detection region in addition to the processing and control by the first means, namely, a processing for controlling a width or a range of detection according to the motion amount of the pixel region. It is made possible to cover the dynamic-false-contour occurrence region using the second means, namely, preliminarily cover the dynamic-false-contour occurrence region with the expanded region so that an influence of an image retention due to motion of the occurrence region is not made. At a time of performing the detection region expansion (width control), a direction of expanding the region is, for example, a direction of a pixel having a higher gray scale in two neighboring pixels, namely, a direction where carry in an SF on-call pattern has been detected. Setting is performed so that an expanded size of the region is at least twice the width, the range, or the number of detection pixels, for example, according to the magnitude of the motion amount.

The further detailed configuration will be explained below. The present digital display apparatus is an apparatus for achieving gray scales using a subfield method based on inputted display data, and has a first means (carry detecting unit) for detecting, as a dynamic-false-contour occurrence region, a first pixel region corresponding to the fact that a first pixel (P1) and a second pixel (P2) in an image of the inputted display data are spatially adjacent and a first subfield on-cell patter corresponding to the P1 and a second subfield on-cell pattern corresponding to the P2 are different in a state of turning on/off (light emitting/not light emitting) a larger weighted subfield (,which is called “carry”). Further, it has a second means for performing, to the first pixel region detected by the first means, a noise addressing processing for coping with the dynamic false contour, such as a diffusion process by dithering or error diffusion. The diffusion process by the error diffusion is a diffusion process obtained by putting error diffusion in practical use and is, for example, a processing (actual gray-scale number restricting processing) for performing data conversion so as to restrict original display data to the number of gray scales less that the total number of gray scales of the original display data.

The digital display apparatus has a motion detection means for detecting a motion amount of each pixel in an image of the inputted display data; and a width control means for determining a second pixel region with a predetermined width or range corresponding to the motion amount detected by the motion detection means in which the first pixel region detected by the first means is centered, namely, for expanding the dynamic-false-contour detection region. The noise addressing processing is performed to the second pixel region determined by the width control means using the second means.

The first means detects, as determination of the adjacent pixel region, the first pixel region by determining gray scales of the P1 and P2 adjacent to each other in a horizontal or vertical direction of the image of the display data.

The detection condition is the case of having relationships such as the following items (1) to (4) and the first means detects, as the first pixel region, a pixel satisfying the condition.

(1) When a gray scale of the P2 is higher than that of the P1, the maximum on-cell subfield SFx of the gray scale of the P2 is turned off at the gray scale of the P1 and a predetermined subfield SFy (y<x) different from the SFx is turned on at the gray scale of the P1 and is turned off at the gray scale of the P2.

(2) When a gray scale of the P2 is higher than that of a pixel of the P1, the SFx with the gray scale of the P2 is turned off at the gray scale of the P1 and a subfield SFx-1 having weighting smaller than that the SFx by one level is turned on at the gray scale of the P1 and is turned off at the gray scale of the P2.

(3) When a gray scale of the P2 is higher than that of a pixel of the P1, the SFxs with the gray scale of the P2 and the gray scale of the P2 are the same and the predetermined subfield SFy (y<x) different from the SFx is turned off at the gray scale of the P1 and is turned on at the gray scale of the P2 and a predetermined subfield SFz different from the SFx and the SFy is turned on at the gray scale of the P1 and is turned off at the gray scale of the P2.

(4) When a gray scale of the P2 is higher than that of the P1, the SFxs with the gray scale of the P1 and the gray scale of the P2 are the same and the predetermined subfield SFy(y<x) different from the SFx is turned off at the gray scale of the P1 and is turned on at the gray scale of the P2 and a subfield SFz having weighting smaller than that the SFy by one level is turned on at the gray scale of the P1 and is turned off at the gray scale of the P2.

When the motion amount detected by the motion detection means is equal to or less than a predetermined value, the width or the range of the second pixel region is eliminated (made zero) by the width control means. That is, the region is handled as not the dynamic-false-contour occurrence region and is processed on a main path.

The second means has a dithering means (dithering unit) for performing a dithering processing to the display data. For example, a configuration where the dithering means is provided in parallel with the actual gray-scale number restriction processing means is adopted and the dither means is selectively applied according to the pixel region. The present apparatus has a means (gray-scale difference comparing unit) for calculating a difference between the gray scale of the P1 and the gray scale of the P2 in the display data to compare a value of the difference with a predetermined value (t), so that only when the value of the difference is equal to or less than the predetermined value (t), the dithering processing by the dithering means is selected and performed. For example, further, the predetermined value (t) is set to a dithering amount that is a control amount in the dithering processing for each gray scale in the display data. In a determining and switching means for switching the processings according to the pixel region on the image, the diffusion processing by the error diffusion and the dither processing by the dithering means is switched with respect to the second pixel region according to the motion amount detected by the motion detection means.

Effects obtained by representative ones of the inventions disclosed in the present application will be explained briefly as follows. According to the present invention, the dynamic false contour in the displayed video image can be reduced or eliminated in the digital display apparatus such as a PDP apparatus and a display method thereof by determining and detecting the occurrence region of the dynamic false contour in the display data with good accuracy for coping.

### BRIEF DESCRIPTION OF THE DRAWINGS

FIG. 1 is an overall configuration diagram of a plasma display apparatus that is a digital display apparatus according to a first embodiment of the present invention;

FIG. 2 is a disassembled configuration view of a plasma display panel of the plasma display apparatus that is a digital display apparatus according to one embodiment of the present invention;

FIG. 3 is a diagram showing a field configuration of a subfield method in the plasma display apparatus that is the digital display apparatus according to one embodiment of the present invention;

FIG. 4 is a block configuration diagram of a dynamic-false-contour detection unit in the plasma display apparatus that is the digital display apparatus according to the first embodiment of the present invention;

FIG. 5A is an explanatory diagram for explaining expansion of the dynamic-false-contour detection unit in the plasma display apparatus that is the digital display apparatus according to the first embodiment of the present invention;

FIG. 5B is an explanatory diagram for explaining expansion of the dynamic-false-contour detection unit in the plasma display apparatus that is the digital display apparatus according to the first embodiment of the present invention;

FIG. 6 is an explanatory diagram showing an example (example 1-1) of a subfield on-cell pattern table in a display method of the digital display apparatus according to one embodiment of the present invention;

FIG. 7 is an explanatory diagram showing an example (example 1-2) of a subfield on-cell pattern table in a display method in the digital display apparatus according to one embodiment of the present invention;

FIG. 8 is an explanatory diagram showing an example (example 1-3) of a subfield on-cell pattern table in a display method in the digital display apparatus according to one embodiment of the present invention;

FIG. 9 is an explanatory diagram showing an example (example 2-1) of a subfield on-cell pattern table in a display method in the digital display apparatus according to one embodiment of the present invention;

FIG. 10 is an explanatory diagram showing an example (example 2-2) of a subfield on-cell pattern table in a display method in the digital display apparatus according to one embodiment of the present invention;

FIG. 11 is an explanatory diagram showing an example (example 2-3) of a subfield on-cell pattern table in a display method in the digital display apparatus according to one embodiment of the present invention;

FIG. 12 is an explanatory diagram showing an example (example 2-4) of a subfield on-cell pattern table in a display method in the digital display apparatus according to one embodiment of the present invention;

FIG. 13 is an explanatory diagram showing an example (example 2-5) of a subfield lighting pattern table in a display method in the digital display apparatus according to one embodiment of the present invention;

FIG. 14 is an explanatory diagram showing an example (example 2-6) of a subfield lighting pattern table in a display method in the digital display apparatus according to one embodiment of the present invention;

FIG. 15 is an explanatory diagram showing an example (example 2-7) of a subfield lighting pattern table in a display method in the digital display apparatus according to one embodiment of the present invention;

FIG. 16 is an overall configuration diagram of a plasma display apparatus that is a digital display apparatus according to a second embodiment of the present invention;

FIG. 17 is a block configuration diagram of a pseudo-contour detection unit in the plasma display apparatuses which are the digital display apparatuses according to the second embodiment and a third embodiment of the present invention;

FIG. 18 is an explanatory diagram for explaining switching between a dithering processing and an actual gray-scale restriction processing in a display method in the digital display apparatus according to the second embodiment of the present invention;

FIG. 19 is an overall configuration diagram of a plasma display apparatus that is a digital display apparatus according to the third embodiment of the present invention;

FIG. 20 is an explanatory diagram for explaining occurrence of the dynamic false contour at a time of carrying in a subfield on-cell pattern of pixels in a plasma display apparatus and in a display method in the conventional art; and

FIG. 21 is an explanatory diagram for explaining noise occurrence due to image retention at a time of a pixel motion in the plasma display apparatus and the display method in the conventional art.

### DESCRIPTION OF THE PREFERRED EMBODIMENTS

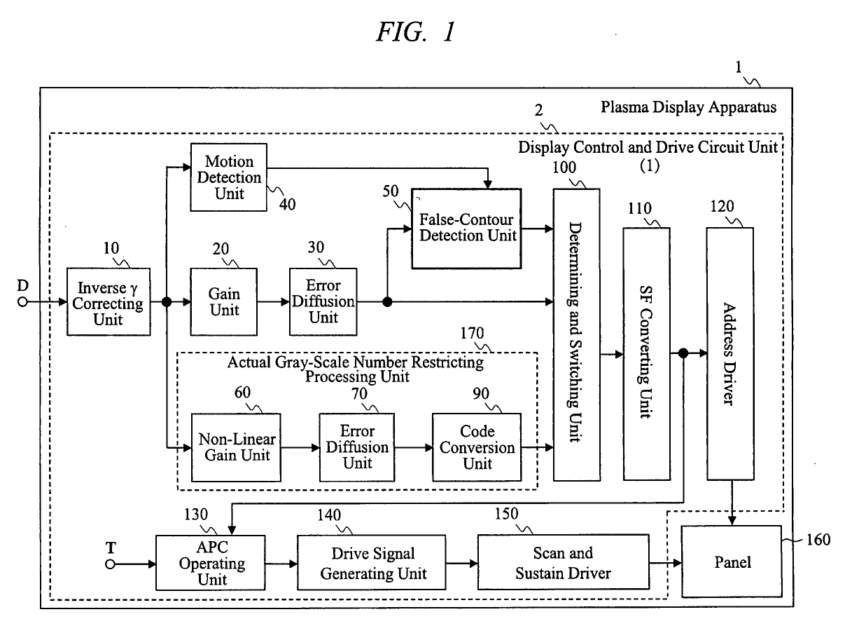

Embodiments of the present invention will be explained in detail below with reference to the drawings. Incidentally, in all the drawings for explaining the embodiments, the same units are denoted in principle by the same reference numerals, and repetitive explanation thereof will be omitted. FIGS. 1 to 19 are the drawings for explaining the embodiments.

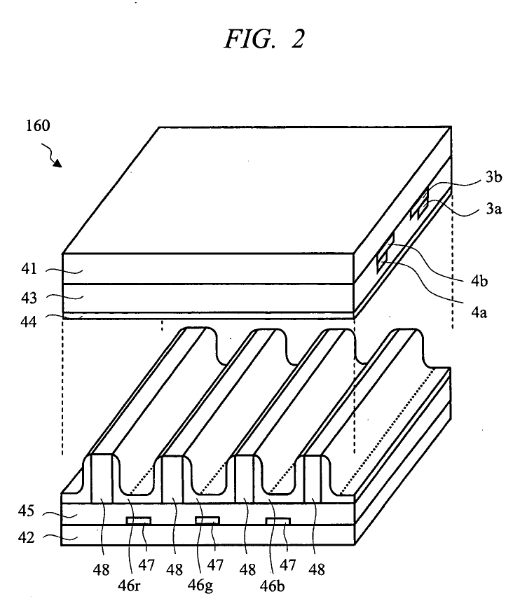

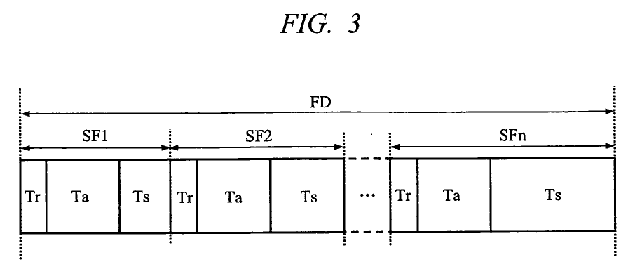

FIG. 1 shows a block configuration of a PDP apparatus 1 that is a digital display apparatus according to a first embodiment of the present invention. FIG. 2 shows, as a configuration of a display cell unit of a panel 160 in the PDP apparatus 1, a configuration before bonding a side of a front substrate 41 and a side of a rear substrate 42 to each other. FIG. 3 shows a field configuration in a subfield method in a fundamental technique.

(First Embodiment)

First, a basic technical configuration will be explained below. In FIG. 1, the PDP apparatus 1 has a display control and drive circuit unit 2, a panel (PDP) 160, and the like. The display control and drive circuit unit (hereinafter, called “circuit unit”) 2 is connected to the panel 160. The circuit unit 2 includes a control circuit (controller) unit for a whole apparatus and a display drive circuit (driver) unit.

A hardware configuration of the PDP apparatus 1 includes, for example, a PDP module in which the panel 160 is bonded to a chassis unit (not shown) and an IC mounting the circuit unit 2 and the like, a power source circuit unit (not shown), and the like are disposed on a back face side of the chassis unit. An end portion of the panel 160 is connected to a driver module (a module where a driver IC and the like are mounted on a flexible substrate) corresponding to the drive circuit unit. The PDP module having such a configuration is accommodated in an external casing so that a PDP apparatus set is configured.

In the circuit unit 2, a display control circuit unit is inputted externally with interface signals including display data (a video image signal) D to perform a signal processing such data conversion or the like. A processing to noise including dynamic false contours is included in the signal processing. The display control circuit unit forms a control signal such as a timing signal T for controlling the drive circuit unit, thereby controlling the drive circuit unit. Each driver drives a corresponding electrode group in the panel 160 according to the display data D and the timing signal T from the display control circuit unit. A display data D to be inputted is in a RGB format and, for example, is composed of signals corresponding to respective colors of R (red), G (green), and B (blue). The display control and drive circuit unit 2 is implemented with hardware such as ASIC (specific use-application integrated circuits).

The circuit unit 2 controls an address driver 120 based upon data signal (D) stored in a memory unit (not shown). According to the timing signal T, the circuit unit 2 also controls the address driver 120, and a scan and sustain driver (corresponding to a X and Y driver) 150, respectively.

The address driver 120 drives a data line (an address electrode) in the panel 160 based upon display data (D). In the scan and sustain driver 150, a scan driver unit drives a scanning line (corresponding to a Y electrode) in the panel 160. In the sustain driver unit, an X driver drives a Y electrode in the panel 160 and a Y driver drives a Y electrode in the panel 160 through the scan driver unit. On a display screen of the panel 160, an address discharge is performed for display cell determination according to driving from the address driver 120 and the scan driver unit. Next, a sustain discharge for display cell light-emission is performed according to driving from the X and Y drivers.

In FIG. 2, the PDP that is the panel 160 is composed of substrates mainly including two sheets of glass of the front substrate 41 and the rear substrate 42. The panel 160 is configured so that the front substrate 41 and the rear substrate 42 is bonded to face to each other via barrier ribs 48 or the like and that an exhausting gas and a discharging gas are encapsulated and sealed in a space between the substrates.

The front substrate 41 has a plurality of first (X) electrodes and second (Y) electrodes extending in parallel with each other in a first direction. Each X electrode and each Y electrode serve as an electrode for a sustain discharge and an electrode for scanning. The sustain discharge is performed between the X and Y electrodes. Each X electrode and each Y electrode are composed of, for example, a bus electrode and a transparent electrode. The bus electrode is a straight bar-shaped electrode that is electrically connected to a driver side and is made from metal. The transparent electrode is an electrode that is electrically connected to the bus electrode and is made of an ITO (indium tin oxide) film forming a discharge slit or the like. In this example, an X transparent electrode 3b and a Y transparent electrode 4b, and an X bus electrode 3a and a Y bus electrode 4a are formed in the front substrate 41 in a three-dimensional manner. The X electrodes and the Y electrodes on the front substrate 41 are covered with a dielectric layer 43 and a protective layer 44.

A plurality of address electrodes 47 (data electrodes) that are third (A) electrodes are disposed in the rear substrate 42 so as to extend approximately in parallel in a second direction perpendicular to the X and Y electrodes. The address electrodes 47 are covered with a dielectric layer 45. A display cell is formed, by a region sandwiched between the X and Y electrodes and crossing the address electrodes 47.

A plurality of barrier ribs 48 for forming stripe-like regions partitioned in a vertical direction (the second direction) are formed between the front substrate 41 and the rear substrate 42. Phosphor layers (46r, 46g, and 46b) of respective colors of R, G, and B are distinctly coated on regions partitioned by the barrier ribs 48. A pixel is composed of display cells of the respective colors. Note that an aspect of providing the barrier ribs in a lateral direction (the first direction) can also be adopted.

In FIG. 3, a subfield method that is a display driving method for the panel 160 that is a PDP is confirmed. As a field configuration, one field (FD) corresponding to one display screen (an image frame) on the panel 160 is composed of a plurality of subfield (SF) weighted and time-divided. For example, one field is composed of ten SFs of SF1 to SF10. Gray scales are achieved by a combination of light emission (on-cell)/no light emission (off-cell) of each of the SFs different in weighting in one field (an SF on-cell pattern). Each SF has a reset period (Tr), an address period (Ta), and a sustain period (Ts) in this order, for example. Each SF is weighted according to difference in the sustain period (Ts), namely, the number of sustain discharge times. For example, different sustain periods (Ts) are applied from the SF1 having the smallest weighting to the SF10 having the largest weighting in order.

In the display drive of the panel 160, remaining charges are first uniformized as an operation at the reset period (Tr), and data memory (accumulation of wall charges) in a target cell is next carried out by an opposite discharge between the A electrode and the Y electrode as an operation at the address period (Ta). Discharge light-emission at the target cell is generated as an operation at a sustain period (Ts) by a surface discharge between the X electrode and the Y electrode.

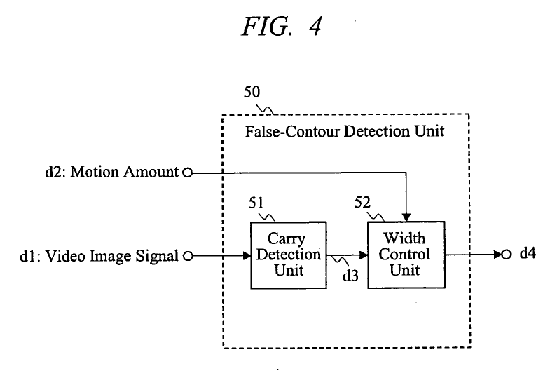

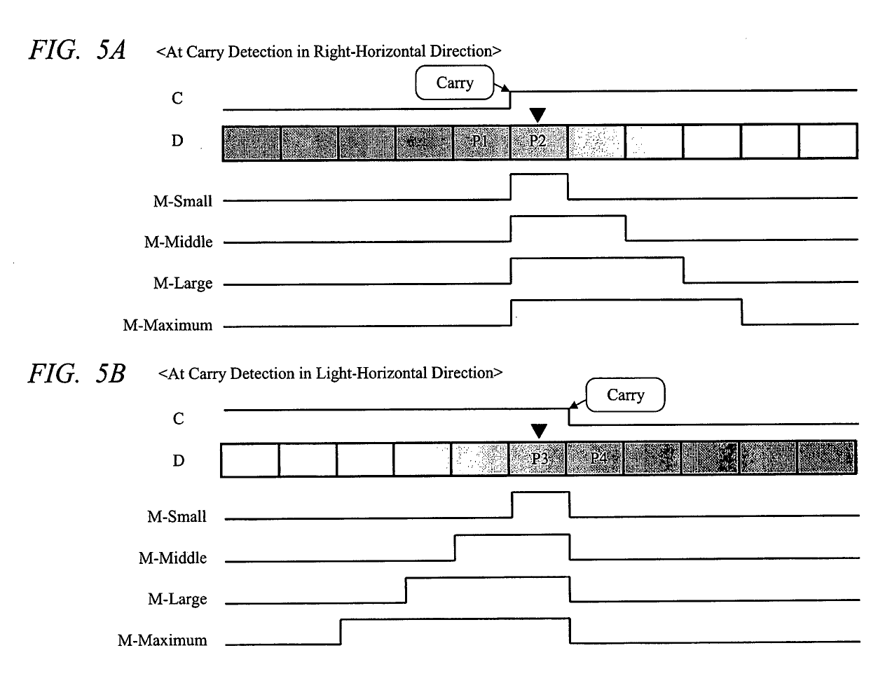

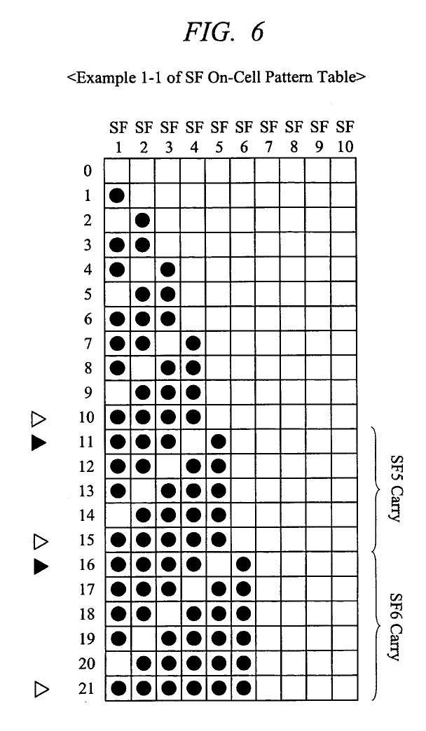

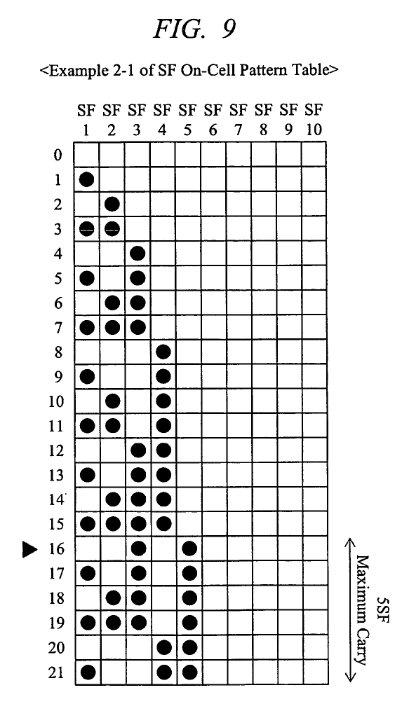

The first embodiment will be explained based upon the above-described basic configuration. FIG. 4 shows a configuration of a false-contour detection unit 50 in the circuit unit 2 of the PDP apparatus 1 according to the first embodiment. FIGS. 5A and 5B show explanation about expansion of a dynamic-false-contour detection region in the display method according to the first embodiment. FIGS. 6 to 8 show an example (example 1) of an SF on-cell pattern table in the first embodiment. FIGS. 9 to 15 show an example (example 2) of an SF on-cell pattern table in the first embodiment.

In the FIG. 1, the display control and drive circuit unit 2 has respective circuit units (blocks) such as a reverse γ correction unit 10, a gain unit 20, a first error diffusion unit 30, a motion detection unit 40, a false-contour detection unit 50, a non-linear gain unit 60, a second error diffusion unit 70, a code conversion unit 90, a determining and switching unit 100, an SF (subfield) conversion unit 110, an address driver 120, an APC operating unit 130, a drive signal generating unit 140, and a scan and sustain driver 150. In the first embodiment, the false-contour detection circuit 50 is a feature unit.

In an actual gray-scale number restricting processing unit 170, an actual gray-scale number restricting processing is performed by the non-linear gain unit 60, the error diffusion unit 70, and the code conversion unit 90. The processing is a processing for restricting kinds of the on-cell patterns (called “actual gray-scale number”) used in the SF conversion unit 110 according to a predetermined condition. The predetermined condition means, for example, on-cell patterns (corresponding to gray scales shown by a white triangle in FIG. 6 and the like) where all SFs having weights smaller than a weight of a specific SF are turned on.

As a path for processing a video image signal (D), there is a main path on a side where the video image signal passes through the gain unit 20 and the first error diffusion unit 30, whereas there is a sub-path on a side where the video image signal passes through the actual gray-scale number restriction processing unit 170. Selection is performed at the determining and switching unit 100 based upon an output (a control signal) of the false-contour detection unit 50 so that an output on a sub-path side is used to the dynamic-false-contour detection region while an output on a main path side is used to regions other than the dynamic-false-contour detection region.

The reverse γ correction unit 10 performs a reverse γ correction processing (adjustment of a relationship among display data, a gray-scale voltage, and an output video image) to an input video image signal (D) to output the same. The motion detection unit 40 detects a region including a motion in an image based upon a difference between one fields and a difference between two fields obtained from a luminance signal in the input video image signal (D). A motion amount information in a motion region is included in the detection result output.

In the main path, the gain unit 20 multiplies the input video image signal (D) by a gain coefficient. Thereby, in the first error diffusion unit 30 at a downstream stage, an error diffusion processing can be performed over a whole region of the input video image signal. The first error diffusion unit 30 performs error diffusion to the video image signal obtained via the gain unit 20. Thereby, a halftone is produced in a pseudo manner, so that the number of gray scales is increased.

In the sub-path, the non-linear gain unit 60 performs correction of a display characteristic and an inverse function after error diffusion in order to obtain a linear display characteristic as a whole, and multiplies corrected results by the gain coefficient to output them. The second error diffusion unit 70 performs error diffusion to the video image signal obtained via the non-linear gain unit 60. Thereby, a halftone is produced in a pseudo manner, so that the number of gray scales is increased. The code conversion unit 90 performs code conversion so that a luminance level on the sub-path is caused to match with that on the main path.

The false-contour detection unit 50 is inputted with an output signal from the first error diffusion unit 30 on the main path, so that it determines a dynamic-false-contour occurrence region based upon the motion amount information from the motion detection unit 40 to detect the same as a dynamic-false-contour detection region and outputs a control signal (a path selection signal).

The determining and switching unit 100 switches the path (the main path/sub-path) to be used depending on an image region of the input video image signal (D), according to the output signal (the path selection signal) from the false-contour detection unit 50. That is, switching between an output of the first error diffusion unit 30 and an output of the code conversion unit 90 is performed so as to select the sub-path to the dynamic false contour detection region, whereby the selected output is outputted to the SF conversion unit 110.

The SF conversion unit 110 performs, based on an output signal from the determining and switching unit 100, conversion to data (SF on-cell pattern data) indicating a gray scale to be turned on and an SF at a time point to be turned on in a video image signal to supply the data to respective drive circuits (120 and 150).

The address driver 120 drives the address electrode in the panel 160 based on data from the SF conversion unit 110. Data addressing in a display cell group in the panel 160 is performed according to driving at the address period (Ta) in the SF.

The APC operating unit 130 performs an operation for a sustain-discharge number setting corresponding to SF weighting with respect to data from the SF conversion unit 110, based on a timing signal T and outputs the data to the drive signal generation unit 140. The drive signal generation unit 140 receives data via the APC operating unit 130, and controls the scan/sustain driver 150 and outputs data to control sustain discharge drive of the panel 160. The scan/sustain driver 150 drives the scan electrode/the sustain electrode of the panel 160 based on the data from the drive signal generation unit 140.

In FIG. 4, the false-contour detection unit 50 has respective circuit units of a carry detection unit 51 and a width control unit 52. The pseudo-contour detection unit 50 performs carry detection, namely, determination and detection of a dynamic-false-contour occurrence region based upon a video image signal (d1) and motion amount information (d2), and performs spatial expansion (namely, width control) of the detection region. The carry detection unit 51 compares signals (the SF on-cell pattern) SF-converted to two adjacent pixels directed in a horizontal direction or in a vertical direction in an image based upon an input of the video image signal (d1) and detects carry or non-carry, namely, a dynamic-false-contour occurrence region according to whether or not the condition (detection condition) described later is satisfied. The carry detection unit 51 transmits a signal (d3) including a signal of a carry detection result and a signal of a carry direction (corresponding to a carry signal C in FIGS. 5A and SB) to the width control unit 52. The width control unit 52 spatially expands a pixel region corresponding to the signal of the carry detection result from the carry detection unit 51, namely, the dynamic-false-contour occurrence region in the carry direction, according to the motion amount information (d2) from the motion detection unit 40, and it outputs a expanded result to the determining and switching unit 100 as a control signal (d4).

In FIGS. 5A and 5B, an example where a pixel region that is a carry detection result is expanded according to a carry direction in determination of the two adjacent pixels is shown for explanation of expansion of the carry detection region in the width control unit 52. The symbol “C” denotes a carry signal, “D” denotes a video image signal, and “M” denotes a motion amount. The case where a gray scale in an adjacent pixel region varies is shown in D, and P1 to P4 correspond to pixels.

An image varies from a dark gray scale to a bright gray scale in a horizontal direction at a carry detection time in a right-horizontal direction shown in FIG. 5A, and this is an example where the carry has been detected between a first pixel (called “P1”) and a second pixel (called “P2”). First, P2 is defined as a dynamic-false-contour occurrence region by the carry detection so that the carry detection result is obtained. Since the P2 of the two adjacent pixels has higher gray scales, a carry direction becomes in a right direction. Accordingly, the original detection region (P2) is expanded in the right horizontal direction of an image according to the degree of the motion amount (d2) as a processing in the width control unit 52. FIG. 5A shows the case where a pixel region is expanded according to four stages of small, middle, large, and maximum of M, for example. When M is in the small range, expansion is set to one time (expansion does not occur) in the adjacent pixel in the carry direction of P2. Similarly, when M is in the middle range, the expansion is set to twice, and when M is in the large range, the expansion is set to three times, and when M is in the maximum range, the expansion is set to four times. The expanded region becomes the dynamic-false-contour detection region and serves as a region covering the image retention region of P2. Note that the expansion method is not limited to the above-described four stages.

An image varies from a bright gray scale to a dark gray scale in a horizontal direction at a carry detection time in a left-horizontal direction shown in FIG. 5B, and this is an example where the carry has been detected between a third pixel (called “P3”) and a fourth pixel (called “P4”). Since a higher gray scale is P3, left-directional detection is obtained. A detection region is expanded in a left direction of an image according to the motion amount like FIG. 5A.

For example, when the motion amount detected by the motion detection unit 40 is equal to or less than a predetermined value, control is made so that determination region in the width control unit 52 is not present.

The determining and switching unit 100 makes determination according to an output signal (d4) from the false-contour detection unit 50 to switch an output. The determining and switching unit 100 selects and outputs an output signal of the code conversion unit 90, namely, a video image signal which has been subjected to actual gray-scale number restriction to the pixel region detected in the false-contour detection unit 50, and it selects and outputs an output signal of the first error diffusion unit 30, namely, a video image signal which has not been subjected to actual gray-scale number restriction to other pixel regions.

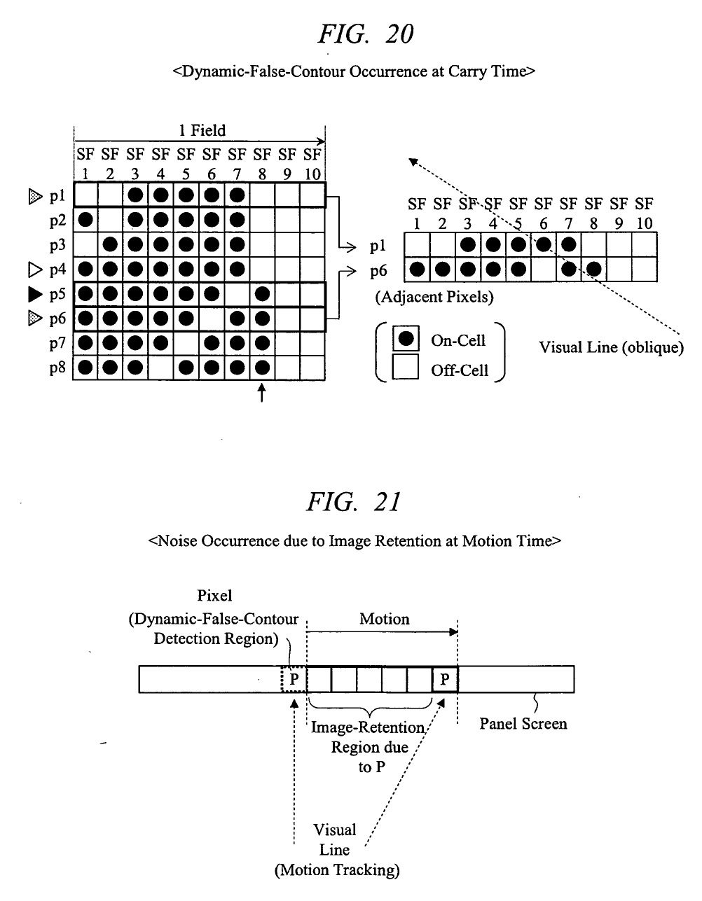

In the false-contour detection unit 50, a first condition at carry detection described above is that, regarding two adjacent pixels (called “P1” and “P2”), when a second gray scale (=gray scale at P2) is higher than a first gray scale (=gray scale at P1), the maximum on-cell subfield SFx at the second gray scale is not turned off at the first gray scale and a predetermined subfield SFy (y<x) different from the SFx is turned on at the first gray scale but turned off at the second gray scale. The maximum on-cell subfield SFx indicates an SF having the maximum weighting of SFs turned on in one field. For example, the maximum on-cell subfield SFx is an SF8 in the case of p5 in FIG. 20.

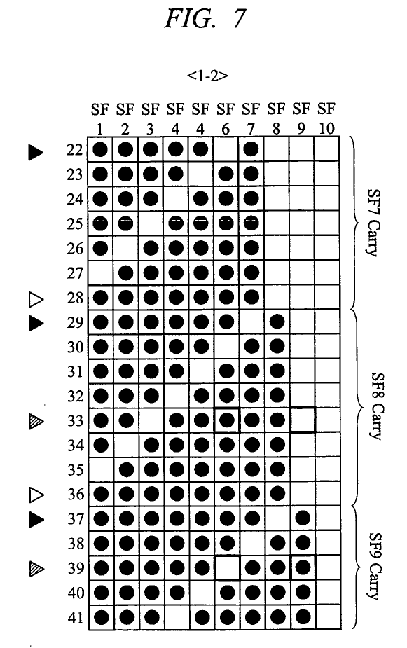

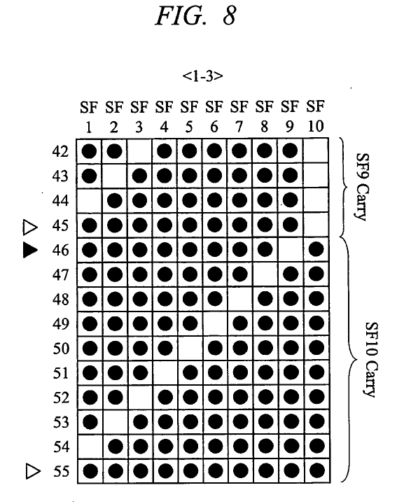

A specific example of the condition and determination will be explained using an example (example 1) of an SF on-cell pattern table shown in FIGS. 6 to 8. It is assumed that one field is composed of SF1 to SF10. FIG. 6 shows an SF on-cell pattern from gray scales 0 to 21, FIG. 7 similarly shows an SF on-cell pattern from gray scales 22 to 41 subsequently thereto, and FIG. 8 shows an SF on-cell pattern from gray scales 42 to 55 subsequently thereto.

In the present embodiment, for example, 11 level gray scale, 16 level gray scale, 22 level gray scale, 29 level gray scale, 37 level gray scale, and 46 level gray scale are carry gray scales, respectively. The carry gray scale is indicated by a black triangle. Incidentally, since influence on noise such as dynamic false contour is reduced according to a decrease in weighting of SF in one field, SF5 or more is considered as a target in this embodiment. These carry gray scales are gray scales carry-detected according to the conventional method.

A gray scale where all on-cell SFs are continuous from SF1, namely, a gray scale without any intermittent off-cell SFs is shown by a white triangle. For example, in gray scale 10 corresponding to the gray scale without a hole, SFx=SF4 and the carry of SFx=SF5 from the gray scale 11 is performed. For example, in the case where the number of gray scales is a 56 level gray scale, eleven gray scales without the holes including the gray scale 0 shown by white triangles are present. In a processing in the actual gray-scale number restriction processing unit 170, a video image signal whose number of gray scales has been restricted is produced using, for example, the specific gray scales shown by the white triangles.

As described previously, the dynamic false contour occurs not only in the above-mentioned carry gray scale but also in two adjacent gray scales (gray scales of two pixels spatially adjacent to each other in an image) between which at least one carry gray scale is sandwiched. For example, when two adjacent pixels (P1 and P2) in an image are the gray scale 33 and the gray scale 39 indicated by shaded triangles in FIG. 7, the gray scale 33 corresponds to the first gray scale and the gray scale 39 corresponds to the second gray scale and these gray scales constitute a set of gray scales between which the gray scale 37 serving as a carry gray scale is sandwiched. SFx of the second gray scale is SF9 and the SF9 at the first gray scale is turned off. The SFy turned on at the first gray scale and turned off at the second gray scale is SF6. Accordingly, these set of gray scales (P1 and P2) satisfies the above-mentioned first condition. Therefore, these pixel regions are detected as dynamic-false-contour occurrence regions according to the carry detection at the gray scale 37.

A second condition at the above-mentioned carry detection is that regarding two adjacent pixels (called “P1” and “P2”), when the gray scale of P2 is higher than the gray scale of P1, SFx of the gray scale of P1 and that of the gray scale of P2 are the same. A predetermined SFy (y<x) different from SFx is turned off at the first gray scale and turned on at the second gray scale, and a predetermined subfield SFz different from SFx and SFy is turned on at the first gray scale and turned off at the second gray scale.

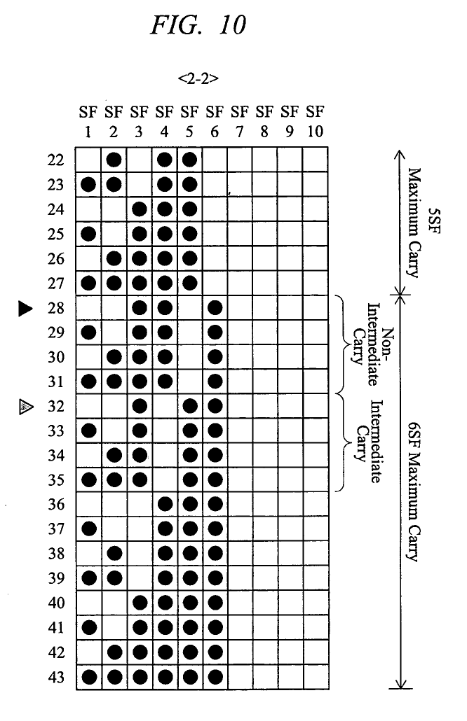

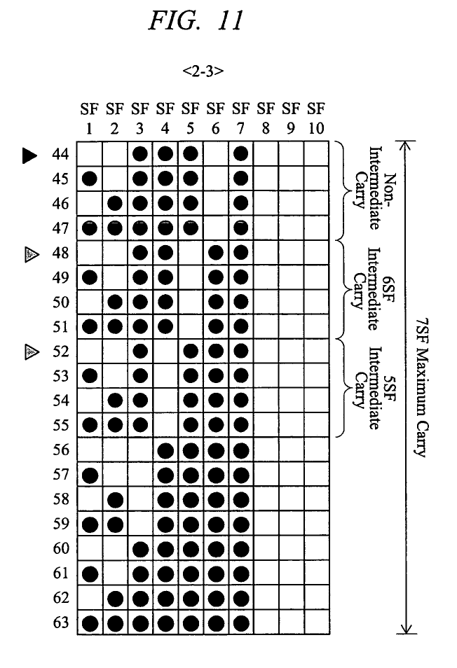

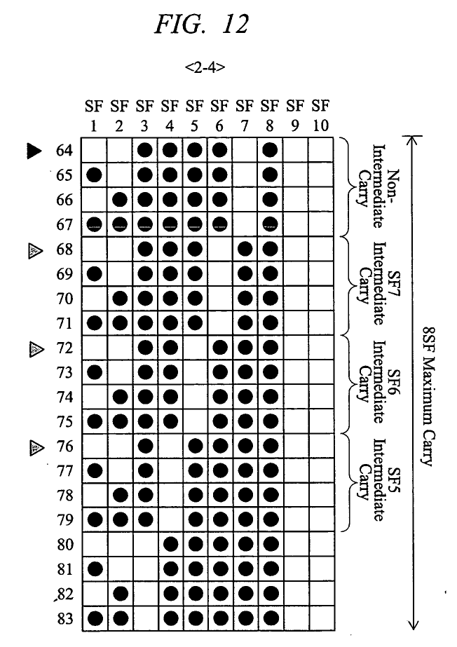

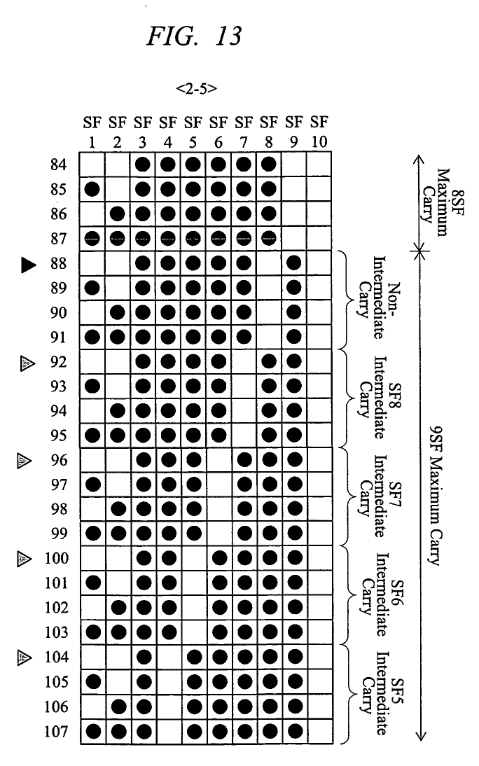

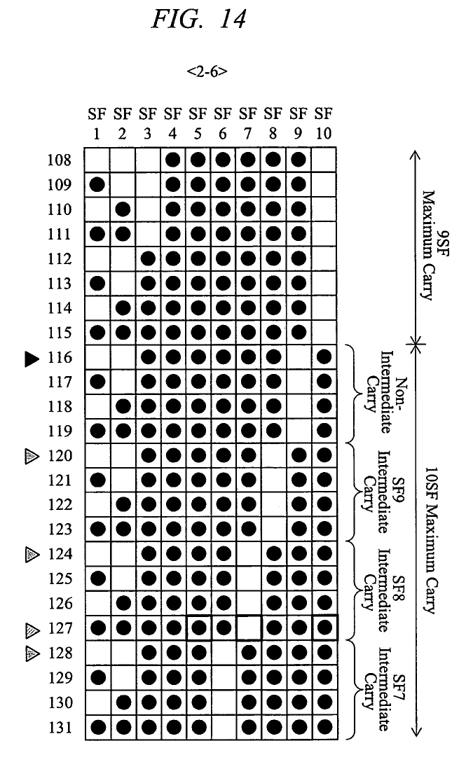

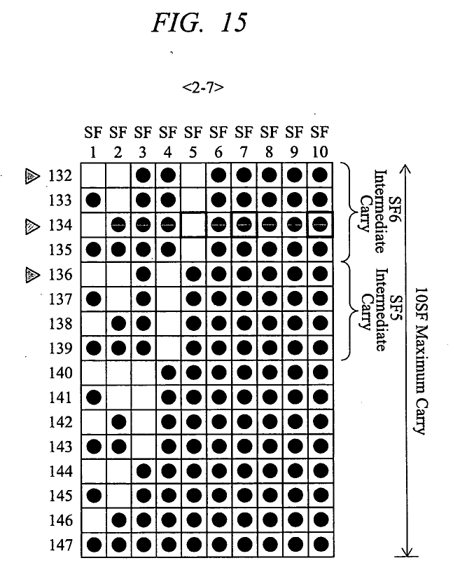

A specific example complying with the second condition will be explained using an example (example 2) of an SF on-cell pattern table shown in FIGS. 9 to 15. FIG. 9 shows an SF on-cell pattern from gray scales 0 to 21. Similarly, FIG. 10 shows an SF on-cell pattern from gray scales 22 to 43 subsequently thereto; FIG. 11 shows an SF on-cell pattern from gray scales 44 to 63 subsequently thereto; FIG. 12 shows an SF on-cell pattern from gray scales 64 to 83 subsequently thereto; FIG. 13 shows an SF on-cell pattern from gray scales 84 to 107 subsequently thereto; FIG. 14 shows an SF on-cell pattern from gray scales 108 to 131 subsequently thereto; and FIG. 15 shows an SF on-cell pattern from gray scales 132 to 147 subsequently thereto.

In this embodiment, the carry occurs in, for example, 16 level gray scale, 28 level gray scale, 44 level gray scale, 64 level gray scale, 88 level gray scale, and 116 level gray scale (shown by black triangles). When two adjacent pixels are pixels between which the carry gray scales are sandwiched, the first condition is satisfied. Further, carry below SFx (called “intermediate carry”) occurs at 32 level gray scale, 48 level gray scale, 52 level gray scale, 68 level gray scale, 72 level gray scale, 76 level gray scale, 92 level gray scale, 96 level gray scale, 100 level gray scale, 104 level gray scale, 120 level gray scale, 124 level gray scale, 128 level gray scale, 132 level gray scale, and 136 level gray scale (shown by shaded triangles). For example, in the gray scales 28 to 31 carried after the gray scale 28, SFx=SF6 and the SF5 is turned off and there is not intermediate carry. The gray scales 32 to 35 subsequently thereto are gray scales where intermediate carry from SF4 to SF5 occurs below SFx=SF6. Two adjacent pixels between which at least one of these intermediate carry gray scales is sandwiched satisfy the second condition.

For example, when two adjacent pixels (P1 and P2) constitute a set of gray scale 127 and gray scale 134 (shown by shaded triangles), the gray scale 127 corresponds to the gray scale of P1 and the gray scale 134 corresponds to the gray scale of P2 and these gray scales constitute a set sandwiching the gray scale 128 and gray scale 132 that are intermediate carry gray scales. Regarding the above-mentioned second condition, SFxs of the gray scale of P1 and the gray scale of P2 are SF10 and SFy turned off at the gray scale of P1 and turned on at the gray scale of P2 is SF7 and SFz turned on the gray scale of P1 and turned off at the gray scale of P2 is SF5. Accordingly, these satisfy the second condition. Therefore, these pixel regions are detected as a false-contour occurrence region corresponding to carry.

In summary, the gray scales of the adjacent pixels in an image of display data (D) is judged, and a whole pixel region is partitioned into some pixel regions described below according to the gray scales (SF on-cell patterns), and the pixel regions are processed. First, the regions of the carry gray scales (weighted) shown by the back triangles are detected as dynamic-false-contour (noise) occurrence regions (a first kind of region) like the conventional method and are processed on the sub-path. Second, the regions of the gray scales satisfying the detection condition and shown by the shaded triangles are detected as dynamic-false-contour (noise) occurrence regions (a second kind of region) based upon the determination by the false-contour detection unit 50 and are processed on the sub-path. Third, regions other than the first kind and the second kind of the regions are processed on the main path.

As described above, in the present embodiment, a dynamic-false-contour occurrence region can be detected not only for each pixel but also based upon determination about the gray scales of the adjacent pixels and be handled by the actual gray-scale number restriction processing, so that display image quality can be improved.

(Second Embodiment)

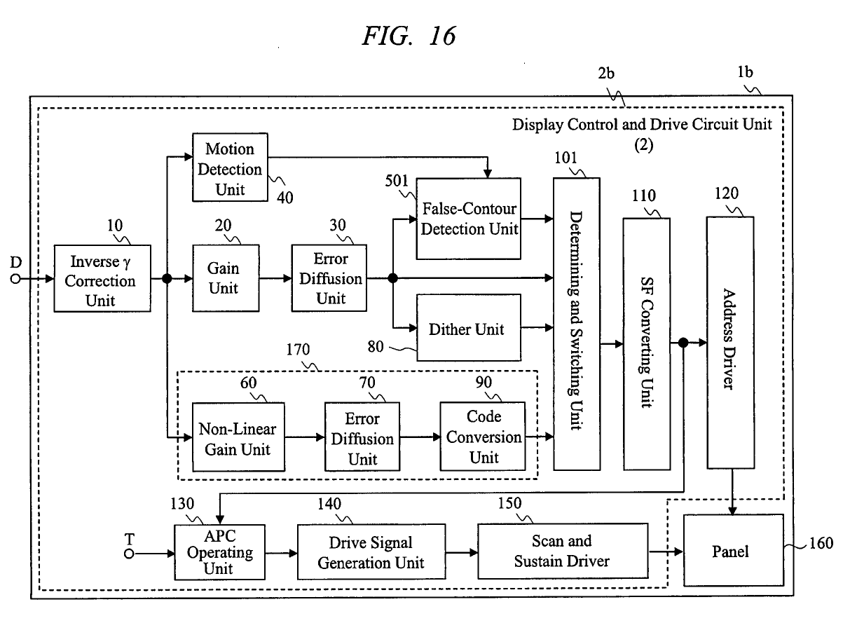

Next, a second embodiment will be explained. FIG. 16 shows a configuration of a PDP apparatus 1b according to a second embodiment of the present invention. A difference between the second embodiment and the first embodiment is that, in a circuit unit 2b, a dither unit 80 is provided and is inserted between a first error diffusion unit 30 and a determining and switching unit 101 and that the false-contour detection unit 50 and the determining and switching unit 100 in the first embodiment are replaced with another false-contour detection unit 501 and another determining and switching unit 101. In the determining and switching unit 100 in the first embodiment, an output signal from the code conversion unit 90 is selected to the dynamic-false-contour detection region. In the second embodiment, however, the determining and switching unit 101 is switched so as to select either one of an output signal from the code conversion unit 90 and an output signal of the dither unit 80 with respect to a dynamic-false-contour detection region.

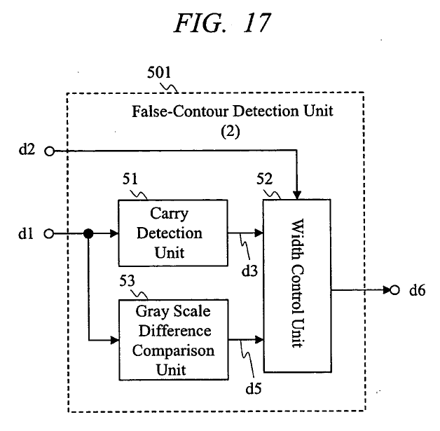

FIG. 17 shows a block configuration of the false-contour detection unit 501. A portion different from the first embodiment will be explained. The false-contour detection unit 501 has a gray-scale difference comparison unit 53 provided at a pre-stage of the width control unit 52 in parallel with the carry detection unit 51. The gray-scale difference comparison unit 53 compares a gray-scale difference between two adjacent pixels compared by the carry detection unit 51 with a predetermined value (threshold t) based upon a video image signal (d1). Then, as the control signal (d5), the gray-scale difference comparison unit 53 outputs “1” to the width control unit 52 when the gray-scale difference is larger than the predetermined value (t), and outputs “0” to the width control unit 52 if not. The width control unit 52 spatially expands, based on the motion amount information (d2) from the motion detection unit 40, the carry detection result (d3) from the carry detection unit 51 in the carry direction and similarly spatially expands an input signal (d5) from the gray-scale difference comparison unit 53 to output the processed video image signal and control signal (d6) to the determining and switching unit 101. In the processing in the gray scale difference comparison unit 53, determination is made about which of processings in the dither unit 80 and in the actual gray-scale number restriction processing unit 170 should be selected. The above-mentioned predetermined value (t) may be set by a control register or the like, for example.

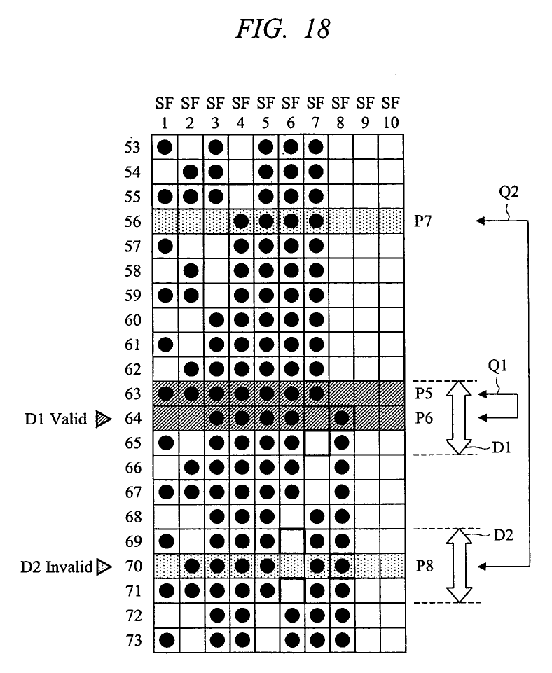

When the above-described predetermined value (t) is set to be equal to or less than a dither amount in a dither processing performed in the dither unit 80, the dither processing functions effectively. FIG. 18 is a view for explaining a switching process between the dither processing and the actual gray-scale number restriction processing. FIG. 18 shows a gray scale of an SF on-cell pattern similar to those in FIGS. 11 and 12. In the gray-scale difference comparison unit 53, an adjacent pixel difference is calculated to be compared with the dither amount. In the case of the “adjacent pixel difference”≦“the dither amount”, the dither processing in the dither unit 80 is selected and if not, the actual gray-scale number restriction processing in the actual gray-scale number restriction processing unit 170 is selected.

When gray scales of two adjacent pixels in a video image signal are constituted by a set (Q1) of the gray scale 63 of P5 and the gray scale 64 of P6 and when “the dither amount”=1, the carry from SF7 to SF8 is detected at P6 as explained above and consequently the dither processing (D1) of “the dither amount”=1 is performed at the dither unit 80 in which P6 is centered. That is, the gray scale 64 of P6 is expressed by diffusing the gray scale 63 and gray scale 65. Since the gray scale 63 and gray scale 65 sandwich the carry gray scale 64 therebetween, the dynamic false contour can be reduced effectively. Since the gray scale 63 and gray scale 65 are different in, for example, a state of SF7, the dither processing (D1) is performed effectively.

On the other hand, when gray scales of two adjacent pixels are constituted by, for example, a set (Q2) of the gray scale 56 of P7 and the gray scale 70 of P8 and when “the dither amount”=1, even if a dither processing (D2) is performed to P8 that is a carry detection pixel, the gray scale 70 of P8 is diffused to the gray scale 69 and gray scale 71, so that a reduction effect of the dynamic false contour is made small. Since states of SF are the same in, for example, the gray scale 69 and gray scale 71, the dither processing (D2) is not effective.

That is, as effective processings for reducing the dynamic false contour by regarding the predetermined value (t) set in the gray-scale difference comparison unit 53 as a dither amount, a carry detection region where the dither processing is effective and a carry detection region where the actual gray-scale number restriction processing is effective are distinguished from each other.

As described above, in the second embodiment, the case where the dither processing is effective to the dynamic-false-contour detection region and the case where it is not are switched based on determination about a difference in gray scale between the adjacent pixels, so that the display video image quality can be improved.

(Third Embodiment)

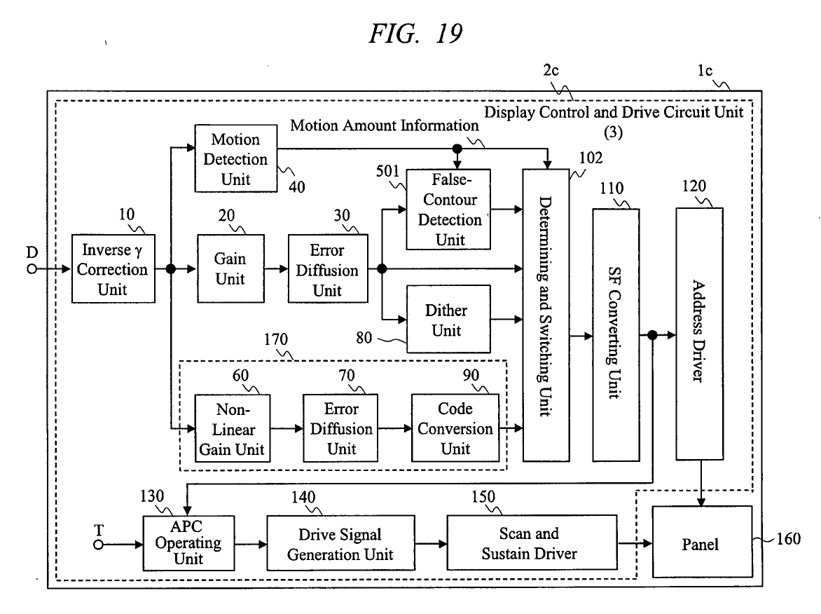

Next, a third embodiment will be explained. FIG. 19 shows a configuration of a PDP apparatus 1c according to the third embodiment of the present invention. A difference between the third embodiment and the second embodiment is in that, in a circuit unit 2c, the motion amount information (d2) that is a result of the motion detection unit 40 is inputted into the determining and switching unit 102 for utilization.

The third embodiment is controlled according to an occurrence status of the dynamic false contour by inputting an output signal (d2) from the motion detection unit 40 to the determining and switching unit 102. In the determining and switching unit 102, switching an output from the dither unit 80 and an output from the actual gray-scale number restriction processing unit 170 is performed to a target pixel region according to a motion amount based on the motion amount information (d2) and the output signal (d6) from the false-contour detection unit 501. When the motion amount is relatively small and when a gray-scale difference between the two adjacent pixels where the dynamic false contours occur is equal to or less than the dither amount, the determining and switching unit 102 selects the output from the dither unit 80. When the motion amount is relatively large and when a gray-scale difference between the two adjacent pixels where the dynamic false contours occur is more than the dither amount, the determining and switching unit 102 selects the output signal from the code conversion unit 90.

As described above, in the third embodiment, delicate control can be performed according to an occurrence status of the dynamic false contour by inputting the output signal (d2) from the motion detection unit 40 to the determining and switching unit 102 as compared with the configuration in the second embodiment.

In the above, the invention made by the present inventors has been specifically explained based on the embodiments. However, needless to say, the present invention is not limited to the embodiments and may be modified variously within the scope of not departing from the gist thereof. The first to third embodiments show the basic configurations, and the present invention can be applied effectively to not only the PDP apparatus 1 described above but also all devices (digital display apparatuses), which include units or means for performing a digital signal processing to display data and displaying it to a display panel unit for a video image according to a subfield method or a method based on the subfield method.

### INDUSTRIAL APPLICABILITY

The present invention can be utilized in various digital display apparatuses such as a PDP apparatus and in a display system.

What is claimed is:

1. A digital display apparatus achieving gray scales using a subfield method based on inputted display data, the digital display apparatus comprising:
a first means for detecting a first pixel region corresponding to the fact that a first pixel and a second pixel in an image of the inputted display data are spatially adjacent and a first subfield on-cell pattern corresponding to the first pixel and a second subfield on-cell pattern corresponding to the second pixel are different in a state of turning on/off a larger weighted subfield; and
a second means for performing a diffusion processing based on dither or error diffusion to the first pixel region detected by the first means.

2. The digital display apparatus according to claim 1, further comprising:
a motion detection means for detecting a motion amount of each pixel in an image of the inputted display data; and
a width control means for determining a second pixel region with a predetermined width or range corresponding to the motion amount detected by the motion detection means in which the first pixel region detected by the first means is centered,
wherein the diffusion processing is performed to the second pixel region determined by the width control means using the second means.

3. The digital display apparatus according to claim 1,
wherein the first means detects gray scales of the first pixel and the second pixel adjacent to each other in a horizontal direction of the image of the display data.

4. The digital display apparatus according to claim 1,
wherein the first means detects gray scales of the first pixel and the second pixel adjacent to each other in a vertical direction of the image of the display data.

5. The digital display apparatus according to claim 1,
wherein the first means detects, as the first pixel region, a case where when a gray scale of the second pixel is higher than a gray scale of the first pixel, a maximum on-cell subfield SFx with a gray scale of the second pixel is turned off in the gray scale of the first pixel and a case where a predetermined subfield SFy (y<x) different from the SFx is turned on in the gray scale of the first pixel and is turned off in the gray scale of the second pixel.

6. The digital display apparatus according to claim 1,
wherein the first means detects, as the first pixel region, a case where when a gray scale of the second pixel is higher than a gray scale of the first pixel, a maximum on-cell subfield SFx with the gray scale of the second pixel is tuned off in the gray scale of the first pixel and a case where a subfield SFx-1 having weighting smaller than that of the SFx by one level is turned on in the gray scale of the first pixel and is turned off in the gray scale of the second pixel.

7. The digital display apparatus according to claim 1,
wherein the first means detects, as the first pixel region, a case where when a gray scale of the second pixel is higher than a gray scale of the first pixel, maximum on-cell subfields SFx with the gray scale of the first pixel and the gray scale of the second pixel are the same and a predetermined subfield SFy (y<x) different from the SFx is turned off in the gray scale of the first pixel and is turned on in the gray scale of the second pixel, and a case where a predetermined subfield SFz different from the SFx and the SFy is turned on in the gray scale of the first pixel and is turned off in the gray scale of the second pixel.

8. The digital display apparatus according to claim 1,
wherein the first means detects, as the first pixel region, a case where when a gray scale of the second pixel is higher than a gray scale of the first pixel, maximum on-cell subfields SFx with the gray scale of the first pixel and the gray scale of the second pixel are the same and a predetermined subfield SFy (y<x) different from the SFx is turned off in the gray scale of the first pixel and is turned on in the gray scale of the second pixel, and a case where a subfield SFz having weighting smaller than that of the SFy by one is turned on in the gray scale of the first pixel and is turned off in the gray scale of the second pixel.

9. The digital display apparatus according to claim 2,
wherein the width control means expands a width or a range of the second pixel region according to a degree of the motion amount.

10. The digital display apparatus according to claim 2,
wherein the width control means expands a width or a range of the second pixel region in a direction of a gray scale detected in the first pixel region.

11. The digital display apparatus according to claim 2,
wherein when the motion amount detected by the motion detection means is equal to or less than a predetermined value, the width or the range of the second pixel region is eliminated by the width control means.

12. The digital display apparatus according to claim 2,
wherein the second means has a dither means for performing a dither processing to the display data, calculates a difference between gray scales of the first pixel and the second pixel in the image of the display data, and selects and performs the dither processing by the dither means only when a value of the difference is equal to or less than a predetermined value.

13. The digital display apparatus according to claim 12,
wherein the predetermined value is a dither amount in the dither processing for each gray scale of the display data.

14. The digital display apparatus according to claim 12,
wherein a diffusion processing based on the error diffusion by the second means and a dither processing by the dither means are switched and performed to the second pixel region according to the motion amount detected by the motion detection means.

15. A display method of a digital display apparatus achieving gray scales using a subfield method based on inputted display data, the display method comprising:
a first step of detecting a first pixel region corresponding to the fact that a first pixel and a second pixel in an image of the inputted display data are spatially adjacent and a first subfield on-cell pattern corresponding to the first pixel and a second subfield on-cell pattern corresponding to the second pixel are different in a state of turning on/off a larger weighted subfield; and
a second step of performing a diffusion processing based on dither or error diffusion to the first pixel region detected by the first step.

16. The display method of a digital display apparatus according to claim 15, further comprising:
a motion detection step of detecting a motion amount of each pixel in an image of the inputted display data; and
a width control step of determining a second pixel region with a predetermined width or range corresponding to the motion amount detected by the motion detection step in which the first pixel region detected by the first step is centered,
wherein the diffusion processing is performed to the second pixel region determined by the width control step using the second step.

17. The display method of a digital display apparatus according to claim 15,
wherein the first step detects, as the first pixel region, a case where when a gray scale of the second pixel is higher than a gray scale of the first pixel, a maximum on-cell subfield SFx with a gray scale of the second pixel is turned off in the gray scale of the first pixel and a case where a predetermined subfield SFy (y<x) different from the SFx is turned on in the gray scale of the first pixel and is turned off in the gray scale of the second pixel.

18. The display method of a digital display apparatus according to claim 15,
wherein the first step detects, as the first pixel region, a case where when a gray scale of the second pixel is higher than a gray scale of the first pixel, maximum on-cell subfields SFx with the gray scale of the first pixel and the gray scale of the second pixel are the same and a predetermined subfield SFy (y<x) different from the SFx is turned off in the gray scale of the first pixel and is turned on in the gray scale of the second pixel, and a case where a predetermined subfield SFz different from the SFx and the SFy is turned on in the gray scale of the first pixel and is turned off in the gray scale of the second pixel.

19. The display method of a digital display apparatus according to claim 16,
wherein the width control step expands a width or a range of the second pixel region in a direction of a gray scale detected in the first pixel region according to a degree of the motion amount.

20. The display method of a digital display apparatus according to claim 16,
wherein the first step calculates a difference between gray scales of the first pixel and the second pixel in the image of the display data and compares a value of the difference with a predetermined value, and when the value of the difference is equal to or less than the predetermined value, the second step selects and performs a dither processing to the second pixel region.
